(19) United States
(12) Patent Application Publication
(10) Pub. No.: US 2008/0147497 A1
(43) Pub. Date: Jun. 19, 2008

(54) Advertising and content management systems and methods

(76) Inventor: Steven N. Tischer, Atlanta, GA (US)

Correspondence Address: SCOTT P. ZIMMERMAN, PLLC, PO BOX 3822, CARY, NC, 27519, US

(21) Appl. No.: 11/638,273

(22) Filed: Dec. 13, 2006

(51) Int. Cl. G06Q 30/00

(52) U.S. Cl. 705/14; 725/32

(57) ABSTRACT

Methods, systems, and products are disclosed for managing an advertisement time slot. The time slot is associated to an advertisement. Ratings information is sent to advertisers that describes a popularity of content associated with the time slot. An auction is conducted for a first alternate advertisement that will be associated with the time slot. Bids are received from the advertisers to have their advertisements selected as the first alternate advertisement. The advertisers' bids are ranked, and the first alternate advertisement is awarded to a first-ranking advertiser.

### CROSS-REFERENCE TO RELATED APPLICATIONS

This application relates to U.S. application Ser. No. 10/020,779, filed Dec. 14, 2001, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The present invention relates generally to the field of advertising, and more specifically, to advertising management systems and methods in which a new pricing methodology is employed whereby advertising and content categorized as override may be overridden by an advertiser desiring to pay a premium.

### BACKGROUND OF THE INVENTION

Advertisements, also referred to as commercials, are played in between subject portions of a television or radio program, and are the primary source of revenue for television and radio networks. Typically ten to ninety seconds in length, advertisements are grouped together as pre-selected breaks in the broadcast of a program, typically occurring from every few to every fifteen minutes of programming. The number of advertisements and the timing between the placement of the advertisements is dependent on the type of program (e.g., sporting event, sitcom, news program, or movie) and the format of the program (e.g., live or pre-recorded). Television and radio programming, for example, typically include approximately sixteen minutes of advertisements during every hour of programming. Many advertisers use this time as their primary avenue for promoting products, services, and events to consumers.

Advertising rates are generally based on the time slot, popularity of a program, and length of the advertisement. A higher rate is charged for a program with a large audience, due to the theory that more viewers, or listeners, will result in more potential customers receiving the advertisement, which is likely to result in more revenue generated for an advertiser. During the Super Bowl™, for example, a thirty second time spot may cost in the millions of dollars.

Advertisements are not limited to radio and television. In the age of computers, some form of advertisement is displayed on virtually every web-page. Conventional Internet advertising may also be in the form of “pop-up” windows, which are programmed to “pop-up” in their own separate window when a certain web-site is triggered, or opened. Many Internet service providers and search-engine companies are able to offer free services to consumers because of the large amounts of advertising dollars that they receive from advertisers. Like television and radio, the more popular a particular web-site is, the more that it is accessed by consumers, and the more the owner may charge for advertising space.

Advertising is generally more effective when products and services reach consumers that have an interest in the particular product or service. This is referred to as “targeted advertising,” in which an advertiser identifies a group of people as being those that are likely to purchase what is being advertised, and providing the most favorable situation in which the advertisement will reach that pre-determined group of consumers. As an example, it is generally known that a lot of men like sports. It is also generally known that a lot of men drink beer. Therefore, it makes economic sense for an advertiser to run a beer advertisement during sporting events, when it is more likely that men will be watching television. As stated above, advertisement time during the Super Bowl™ very expensive, and although very expensive, it is common to see a large number of beer commercials during the Super Bowl™. This is normally because advertisers feel that the large premiums paid for time slots during the game will be made-up for by the amount of revenue that the commercial will generate for the company through beer sales.

In determining whether a program, or web-page, may be appropriate for a particular advertisement, advertisers typically consider whether the program attracts large numbers of viewers who are of the same age group, gender, income bracket, and who have similar interests and hobbies with those who are most likely to purchase the product being advertised. Selecting an advertisement and advertising slot in this manner, increases the likelihood that viewers who watch the advertisement will be interested viewers.

Broadcasting networks and advertisers are able to gauge which demographic groups are watching which programs using conventional market research tools. For example, the AC Nielsen™ ratings system tracks television viewing activities by sampling a plurality of households, and estimating the number of viewers of particular programs using the viewing activity data. Advertisers also use market research companies which conduct focus groups that study the effectiveness of different types of television advertisements. These market research tools assist advertisers in creating advertisements, and selecting appropriate time slots in which to run them. To help ensure that viewers watch a particular advertisement, advertisers use techniques that help to grab a viewers attention, such as visual stimulus, catchy slogans, and jingles.

To gauge the effectiveness of their spending, advertisers have long sought information related to potential consumer viewing patterns. There are several conventional devices and techniques that exist for gathering such information. For example, U.S. Pat. No. 4,258,386 issued to Cheung discloses “an apparatus for television audience analysis comprising means for monitoring a television receiver, means responsive to a monitored signal for storing information representative of channel identification and of the time at which a channel is selected and at which the selection of a channel is terminated, and means for reading the stored information periodically.”

As another example, U.S. Pat. No. 4,556,030 issued to Nickerson, et al., discloses “a data storage and transmission system for accumulating and transmitting data from a plurality of remote T.V. panelist locations to a central location. Each remote unit includes a microprocessor, a control memory, and a data store memory. The control memory stores control information for the remote unit, which may include dynamic allocation information. The data store memory is event driven and stores data as to television channel selection and times thereof, and can store viewer reaction data and the like. At a pre-selected time, each remote unit initiates a telephone call to a central location and identifies itself. Upon successful telephone connection between a remote unit and the central location, any data such as viewer habit and/or reaction data and the like contained in the data store memory is transmitted over the telephone line to the central location.”

Other conventional systems and methods provide somewhat more use data than only channel numbers viewed and the time of viewing, such as which products panelists purchase. U.S. Pat. No. 4,816,904 issued to McKenna, et al., discloses “a data gathering system including a plurality of remote units which are controlled from a central location. Each of the remote units are attached to a television receiver which is generally, but not necessarily, attached to a cable system. Each of the remote units may function to determine which of several TV modes is in use as well as to store TV channel selector data, data from an optical input device, and/or data input by viewers representative of the composition of the viewing audience. The data is stored for either later collection by a portable data collector, or for direct transmission via telephone to the central location. A video message for a TV viewer, such as a survey, may be transmitted from the central location and stored at the remote units, for later display on the TV receiver associated with the remote units. The substitution of alternate programming information may also be achieved by the central control point on selected of the remote units.”

Conventionally, panelist monitoring may be used to gauge the effectiveness of advertising on a selected group of panelists. Nevertheless, while panelist monitoring systems like those described above provide somewhat more monitoring data than just TV tuning data, they do so only for limited groups. For example, when more data is gathered (like purchase information), it is done only for the panelist groups, rather than for subscribers of the entire system.

Conventional systems typically capture ratings information that identifies which television shows are viewed, rather than whether the subscriber also viewed the commercials displayed during those shows. What is important to an advertiser is that potential consumers are interested in an advertisement enough to sit through its duration. There is a great deal of money invested in advertising, with the hopes that it will return even greater profits.

Conventional advertising management systems comprise what is generally referred to as a “locked” advertisement delivery system. In this conventional system, time slots are pre-purchased by advertisers. The rates for these time slots are based upon the demand for the particular time slot, as described above. When time slots are purchased, they are grouped together and run as a commercial break during a program, also as described above. When a time slot is purchased, it is no longer available to a second advertiser that may be interested in purchasing the same time slot, but who did not purchase it first. Conventional advertising management systems are basically first-come-first-serve. There may be bidding for a particular slot, but once a rate is agreed to by the advertising slot provider, that time slot is set.

Conventional advertising methods include several drawbacks, such as excluding potential consumers, and including viewers that have no desire to purchase the product or service. Advertisers must continuously evaluate advertising mediums and time slots. When selecting time slots, advertisers take into account which times of the day they are most likely to find large volumes of viewers, whether or not those viewers are of a desired demographic, and which programs are most appropriate to place advertisements into.

What is needed are novel systems and methods that result in more effectively spent advertising dollars for advertisers, which results in increased profit margins for the advertisers and also for network media providers. What is needed are novel systems and methods which result in flexibility and options for advertisers in selecting advertising time slots.

### BRIEF SUMMARY OF THE INVENTION

In a preferred embodiment, the present invention provides a pricing methodology whereby scheduled advertising content broadcast to potential consumers may be overridden and replaced by advertising content from an advertiser paying a premium. The method includes a first advertiser occupying an advertisement time slot with a first advertisement, categorizing the first advertisement as an overrideable advertisement or a non-overrideable advertisement, receiving a request from a second advertiser to replace the first advertisement with a second advertisement, and if it is determined that the first advertisement is categorized as an appropriate override advertisement, replacing the first advertisement with the second advertisement. The second advertisement is then broadcast to consumers in place of the first advertisement. Advertisements are broadcast to potential consumers via a broadcast transmission, wherein the broadcast transmission may include a television broadcast, a radio broadcast, and a broadcast sent over the Internet and received on a personal computer.

Various pricing structures may be employed. In one embodiment, the method further involves pricing an overrideable advertisement at a lower price than a non-overrideable advertisement, and wherein a premium is paid to replace the first advertisement with the second advertisement.

A request to replace the first advertisement with the second advertisement may be based upon data obtained using marketing tools and programming ratings collection and analysis systems to identify most-valuable and least-valuable viewers. The ratings collection and analysis systems may track program viewing activities by sampling a plurality of households and estimating the number of viewers of the programs using viewing activity data, focus groups that study the effectiveness of different types advertisements, and product sales reports.

In an alternative embodiment, the advertisement management method further includes receiving requests, and processing, storing, managing, and inserting advertisements using an interactive server. The interactive server compares the second and/or first advertisement with a plurality of pre-determined criteria, and if the advertisement meets a pre-selected number of the plurality of criteria, the interactive server may replace the first advertisement with the second advertisement.

In a further embodiment, the present invention provides a system for managing advertisement programming including a first advertisement provided by a first advertiser, a second advertisement provided by a second advertiser, and an interactive server of a network content provider, wherein the interactive server is operable for replacing the first advertisement with the second advertisement if a plurality of pre-determined criteria are met.

Embodiments of the present invention provide various advantages, such as novel advertisement pricing methodologies, advertisement time slot purchasing options, and targeted advertising methodologies. Embodiments of the present invention provide methods of effective advertising management and targeting that ensure that a particular demographic group receives the most appropriate materials.

A method is disclosed for managing an advertisement time slot. The time slot is associated to an advertisement. Ratings information is sent to advertisers that describes a popularity of content associated with the time slot. An auction is conducted for a first alternate advertisement that will be associated with the time slot. Bids are received from the advertisers to have their advertisements selected as the first alternate advertisement. The advertisers' bids are ranked, and the first alternate advertisement is awarded to a first-ranking advertiser.

A system is also disclosed for managing an advertisement time slot. The system is operative to associate the time slot to an advertisement. Ratings information is sent to advertisers that describes a popularity of content associated with the time slot. An auction is conducted for a first alternate advertisement that will be associated with the time slot. Bids are received from the advertisers to have their advertisements selected as the first alternate advertisement. The advertisers' bids are ranked, and the first alternate advertisement is awarded to a first-ranking advertiser.

Additional objects, advantages, and novel features of the invention will be set forth in part in the description which follows, and in part will become more apparent to those skilled in the art upon examination of the following, or may be learned by practice of the invention.

### BRIEF DESCRIPTION OF THE DRAWINGS

These and other features, aspects, and advantages of the exemplary embodiments are better understood when the following Detailed Description is read with reference to the accompanying drawings, wherein:

FIG. 1 is a exemplary hardware environment of the present invention in which a network provider responds to a request from an advertiser using data obtained from an interactive server;

FIG. 2 is a functional block diagram illustrating one embodiment of the present invention in which an advertiser desiring to replace a scheduled advertisement contacts a network provider; and

FIG. 3 is a functional block diagram illustrating one embodiment of the present invention in which an advertiser desiring to replace a scheduled advertisement contacts a network provider and ultimately an interactive server,

FIG. 4 is a simplified schematic illustrating another exemplary operating environment;

FIGS. 5-7 are more detailed schematics illustrating management of the advertisement time slot, according to more exemplary embodiments; and

FIGS. 8-10 are flowcharts illustrating methods of management of an advertisement time slot, according to even more exemplary embodiments.

### DETAILED DESCRIPTION OF THE INVENTION

As required, detailed embodiments of the present invention are disclosed herein, however, it is to be understood that the disclosed embodiments are merely exemplary of the invention that may be embodied in various and alternative forms. Specific structural and functional details disclosed herein are not to be interpreted as limiting, but merely as a basis for the claims as a representative basis for teaching one skilled in the art to variously employ the present invention. Conventional hardware and systems are shown in block diagram form and process steps are shown in flowcharts.

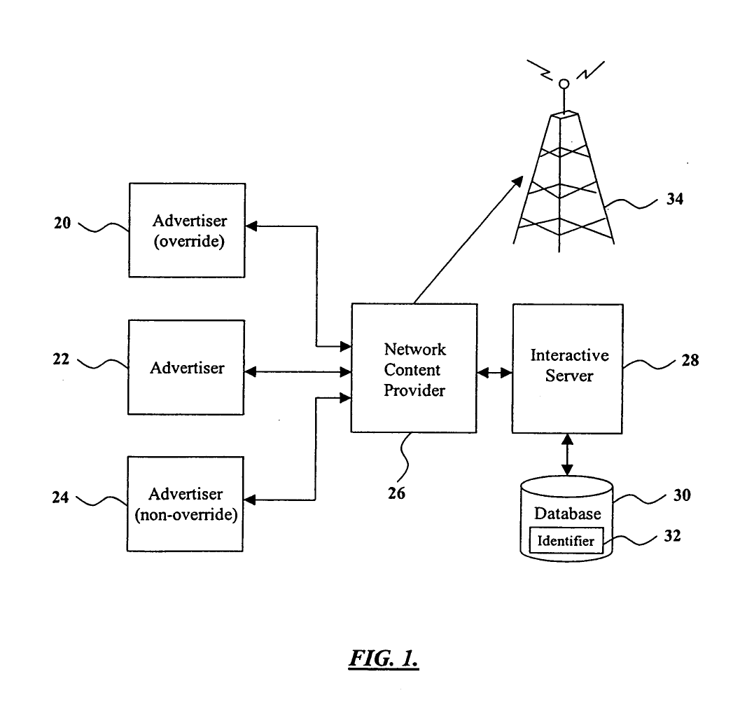

Referring now to the drawings, in which like numerals indicate like elements throughout the several figures, FIG. 1 illustrates an exemplary hardware environment in which programming content delivered in a scheduled lineup may be overridden by an advertiser desiring to pay a premium. FIG. 1 illustrates various system elements and subsystems that communicate with each other to transmit collected data information and data acknowledgments. The term scheduled is used herein to include the delivery of advertising and content whereby a fixed array of content programming is provided, and payments are made by advertising and content providers based upon that fixed array.

In one embodiment, a first advertiser 20 has a first advertisement already inserted into a scheduled broadcast to be transmitted in the future. The first advertisement has been categorized as an override advertisement, as discussed above. A second advertiser 22 has a second advertisement that is not yet inserted into any broadcast transmission, but desires to insert the second advertisement into the same broadcast transmission as the first advertiser 20. A third advertiser 24 has a third advertisement already inserted into the same broadcast transmission as the first advertiser 20. The third advertisement has been categorized as a non-override advertisement, as will be discussed below. All three advertisers 20, 22, 24 are in communication with a network content provider 26 that controls the broadcast and manages the advertisements.

The network content provider 26, responsible for providing a network service in which advertisements are broadcast to potential consumers, operates and maintains a system equipped to receive signals and other content from the advertisers 20, 22, 24. The network content provider 26 may be any original or secondary source of network programming including, for example, television, radio, Internet, or like digital environment. Content providers 26 may broadcast directly to potential consumers, or alternatively, may broadcast to a provider that receives and retransmits a broadcast to potential consumers. The advertisers 20, 22, 24 furnish content originated by them to the network content provider 26 that incorporates that content into the network content provider's 26 broadcast.

The system of FIG. 1 comprises an interactive server 28 operable for advertisement management. As is shown, the network content provider 26 and the advertisers 20, 22, 24 are connected to the interactive server 28 via the network content provider 26. The interactive server is capable of managing advertisements, receiving requests, checking a plurality of pre-determined criteria, and responding to the requests from the advertisers 20, 22, 24.

Signals containing requests and programming content furnished by the advertisers 20, 22, 24 are sent via suitable communication paths to content provider 26 and ultimately to the interactive server 28 comprising a processor for processing information. A provisioning technique available to an advertiser 22 with Internet access includes a Web-based form of entry of advertisement information. Using such a technique, an advertiser 22 using a browser running on a computer with an Internet connection accesses the interactive server and inputs requests and receives responses. Requests may include specific information relating to a particular advertisement or time slot, such as override and non-override categorization, and the override option. Advertisement schedules, characteristics, identifiers, and pricing may be stored in a database 30 of the interactive server 28. Each individual advertisement may have an associated identifier 32 that is used to identify the specific advertisement. The identifier 32 may include descriptive information such as the time length of the advertisement and file size. When a signal is received by the interactive server 28, the interactive server 28 identifies the selected advertisement and may insert it into a program time slot using if a series of checkpoints are completed and approved, as discussed above.

The network content provider 26 is able to insert the advertisement, identified by the interactive server 28 using its identifier, into the broadcast transmission 34. The primary functionality of the network content provider 26 is provided by the interactive server 28, which stores and manages the advertisements provided by the advertisers, and which responds to requests from the advertisers.

In one embodiment of the present invention, a provisioning method is provided in which an advertiser may access the interactive server 28 and override a prescheduled advertisement based on monitoring and marketing tools. The monitoring and marketing tools provide data to an advertiser which aid in selecting the most desirable time slot for each particular advertisement based on the data. Using data gathered regarding viewing habits, such as set top boxes use for monitoring viewing habits and collecting information, to distinguish more-valuable from less-valuable viewers, along with override and non-override categories, content and advertisements may be matched with more-valuable and less-valuable viewer subsets.

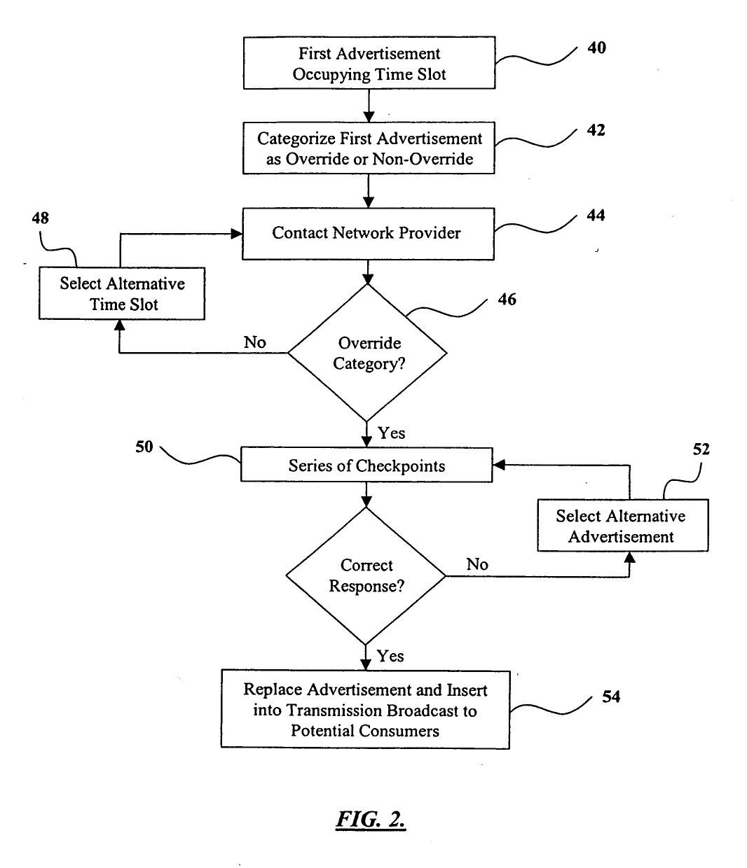

FIG. 2 illustrates a preferred embodiment of an advertising management method in which an advertiser, by paying a premium, may replace a scheduled advertisement with a different advertisement. The method includes a first advertiser having a first advertisement that is scheduled to be broadcast at some time in the future (Block 40). The first advertisement may be part of a group of advertisements which are shown at pre-determined times during a subject program. Typically, one hour of programming usually includes about sixteen minutes of advertising. Each advertisement corresponds with a time slot, and time slots are grouped together to form a commercial break in the programming schedule.

The present invention establishes a pricing methodology whereby an advertisement categorized as override may be overridden, or replaced. When providing an advertisement to a network provider for broadcast, an advertiser has the option of categorizing the advertisement as either an override or a non-override advertisement (Block 42), and paying a corresponding fee based on the category chosen. In an alternative embodiment, a network provider may offer time slots that are pre-categorized as either override or non-override, and an advertiser may purchase a time slot based upon the desired category. Overrideable is hereby defined as capable of being replaced. Non-override is hereby defined as not capable of being replaced. An overrideable advertisement is an advertisement that may be broadcast, or, may be replaced by a different advertisement, either from the same or a different advertiser. A non-overrideable advertisement is an advertisement that will be broadcast, and is not capable of being replaced.

In the preferred embodiment, an advertisement, or time slot, categorized as override is priced at a lower cost than an advertisement, or time slot, categorized as non-override, for the reason that an override advertisement may not be broadcast if replaced. An advertiser may opt to purchase this advertising option due to its lower price. An advertiser may also opt to purchase the option based upon information that may lead the advertiser to believe that their advertisement will most likely not be overridden. The information may include such items as the time of day, the day of the week, the program that the advertisement will be shown during, time slot demand, marketing tools, and previous advertiser replacements. For example, if an advertiser has a limited advertising budget, the advertiser may opt to categorize his/her advertisement as an override advertisement based upon time slot demand and the past history of replacements made during the desired time slot. In another example, if an advertiser has a very limited potential consumer audience that also coincides with a low-demand time slot, the advertiser may choose the lower priced overrideable option to save money.

In the preferred embodiment, an advertisement, or time slot, categorized as non-override is priced at a higher cost than an advertisement, or time slot, categorized as override, for the reason that a non-override advertisement will be broadcast and can not be replaced. An advertiser may opt to purchase this advertising option due to demand and projected audience value. An advertiser may also opt to purchase the option based upon information that may lead the advertiser to believe that the greater cost will lead to greater revenues. The information may include such items as the time of day, the day of the week, the program that the advertisement will be shown during, time slot demand, marketing tools, and previous advertiser replacements.

In the preferred embodiment, an advertiser wishing to override the first advertisement with the second advertisement may be required to pay a premium. The amount of the premium may vary based upon the time slot desired and the characteristics and content of the subject matter surrounding the commercial break. For example, desired override advertising time during a live one-time championship sporting event may be priced at a much higher amount than override advertising time during a regularly scheduled program due to the special nature of the program.

Network providers, such as television and radio, sell advertising space based on the length of time of an advertisement, the day of the week, the time of day, advertiser demand, and the type of program the advertisement will be played during. Most television viewers watch television during the prime-time viewing hours of about 7 pm to about 10 pm, and network providers, therefore, charge higher rates during these viewing hours due to advertiser demand. Internet network providers may sell advertising time based on file size and type, and may also set fees based on the time of day, the day of the week, and specific programs.

Content delivered to a network content provider by an advertiser includes advertisements relating to products, services, and events. The advertisements, in one example referred to as commercials, are played in between the subject potions of the network content providers program. Referring to television and radio broadcasts, advertisements range from about ten to about ninety seconds in length, and are grouped together as pre-selected breaks in the broadcast of the program, occurring every few minutes of programming. The number of advertisements and the timing between the placement of the advertisements is dependent upon the type of program (e.g., sporting event, sitcom, news program, or movie) and the format of the program (e.g., live or pre-recorded). Television and radio programming, for example, typically include approximately sixteen minutes of advertisements during every hour of programming.

The method further includes a second advertiser, having a second advertisement, desiring the time slot occupied by the already scheduled first advertisement. The second advertiser then contacts the appropriate network provider that is in charge of the scheduling of the desired time slot, to inquire about overriding the first advertisement and replacing it with the second advertisement (Block 44). As stated above, only an advertisement categorized as override is capable of being overridden. The network provider then informs the second advertiser of the category of the first advertisement or time slot (Block 46).

The network content provider (26, FIG. 1) checks the first advertisements category and may determine that the first advertisement is an override advertisement, in which case the second advertiser has the option of overriding, or replacing the first advertisement with a second different advertisement. The network content provider 26 may determine that the first advertisement is a non-override advertisement, in which case the second advertiser is not able to replace the first advertisement and must either choose a new first advertisement or time slot (Block 48), or opt not to proceed.

After the network content provider (26, FIG. 1) determines that the first advertisement is capable of being overridden, the network provider 26 goes through a series of checkpoints (Block 50) to determine if the second advertisement may be inserted into the broadcast in the place of the first advertisement. A correct response to the series of checkpoints will lead to the replacement of the first advertisement with the second advertisement (Block 54). An incorrect response to the series of checkpoints leads to the advertiser having to choose an alternative second advertisement to be inserted (Block 52), or opting not to proceed.

The series of checkpoints may include the first and second advertisements lengths in time, the proper fees, technical specifications, and a search to determine when the last time that an advertisement was broadcast relating to the same or similar type product. The time length requirement is to ensure that the second advertisement is an appropriate fit and will not result in a disruption in the broadcast transmission. The proper fees checkpoint is to ensure that a premium has been paid, or will be paid, by the advertiser to override the first advertisement. Technical specifications may include such items as formatting and an appropriate amount of time necessary to implement the change without a causing a disruption in the broadcast transmission. Other technical specifications will be well-known to those of ordinary skill in the art.

To illustrate the series of checkpoints, for example, assume that an advertiser of a sport-utility automobile desires to replace a first sport-utility automobile advertisement, of a competitor, with a second advertisement. The advertisement substitution may involve the network content provider (26, FIG. 1) and ultimately the interactive server (28, FIG. 1) running through a series of checkpoints to determine if a substitution is possible and appropriate. The series may involve verifying that the first advertisement is indeed an advertisement categorized as overrideable. Once verified, the network provider 26 may then determine whether the second advertisement possesses the required characteristics in order to replace the first advertisement, such as equal or near in length time lengths and whether the second advertisement has been recorded in a compatible format with the scheduled broadcast. A further checkpoint may include a search by the network provider 26 or interactive server 28 to determine when the last time an advertisement was broadcast relating to a sport-utility vehicle, or any vehicle, either by the same or different advertiser. The network provider 26 may opt not to replace the first advertisement if the second advertiser had a similar advertisement run in the recent past, such as a term of a few hours.

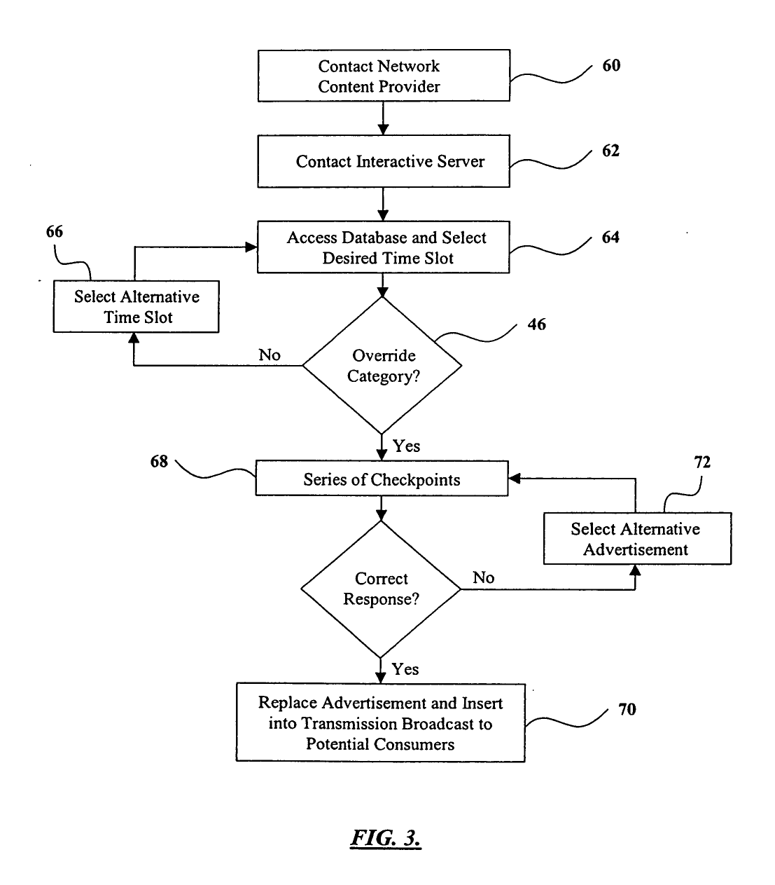

Referring to FIG. 3, in an alternative embodiment, the pricing methodology discussed above may include the interactive server (28, FIG. 1) operable for advertisement management. The method includes a first advertiser having a first advertisement already inserted into a scheduled broadcast that will be transmitted in the future (Block 40, FIG. 2). The second advertiser having a second advertisement desires the specific time slot occupied by the first advertisement. The second advertiser first contacts the network content provider (Block 60) and ultimately the interactive server 28 of the network content provider (Block 62).

The interactive server 28 receives a request from the second advertiser 22 regarding specifications and override options relating to the first advertisement. The interactive server 28 accesses and retrieves information from the database (Block 64). As stated above, only an advertisement categorized as override is capable of being overridden. The interactive server 28 transmits the requested information to the second advertiser regarding the first advertisement, information including categorization.

The network content provider (26, FIG. 1) checks the first advertisements category (Block 46, FIG. 2) and may determine that the first advertisement is an override advertisement, in which case the second advertiser has the option of overriding, or replacing the first advertisement with a second different advertisement. The network content provider 26 may determine that the first advertisement is a non-override advertisement, in which case the second advertiser is not able to replace the first advertisement and must either choose a new first advertisement or time slot (Block 66), or opt not to proceed.

After the interactive server 28 determines that the first advertisement is capable of being overridden, the interactive server 28 runs through a series of checkpoints (Block 68) to determine if the second advertisement may be inserted into the broadcast in the place of the first advertisement. A correct response to the series of checkpoints will lead to the replacement of the first advertisement with the second advertisement (Block 70). An incorrect response to the series of checkpoints leads to the advertiser having to choose an alternative second advertisement to be inserted (Block 72), or opting not to proceed.

As stated above, the series of checkpoints may include the first and second advertisements lengths in time, the proper fees, technical specifications, and a search to determine when the last time that an advertisement was broadcast relating to the same or similar type product. The time length requirement is to ensure that the second advertisement is an appropriate fit and will not result in a disruption in the broadcast transmission. The proper fees checkpoint is to ensure that a premium has been paid, or will be paid, by the advertiser to override the first advertisement. Technical specifications may include such items as formatting and an appropriate amount of time necessary to implement the change without a causing a disruption in the broadcast transmission. Other technical specifications will be well-known to those of ordinary skill in the art.

In one embodiment, the present invention may acquire data used to select a desired advertising time slot based on a demographics and programming ratings collection and analysis system, as is well known in the art. The ratings collection and analysis systems may track program viewing activities by sampling a plurality of households and estimating the number of viewers of the programs using viewing activity data, focus groups that study the effectiveness of different types advertisements, and product sales reports. Using data gathering technology to identify valuable viewers, override and non-override advertisements may be matched to correspond with most-valuable and least-valuable viewer subsets. In one embodiment, a processor determines valuable viewer subsets by collecting information to create a log about all events or selected events of interest viewed by potential consumers. Other marketing tools may be used to determine valuable viewer subsets, and the information obtained using these marketing tools may aid an advertiser in making decisions regarding when to override a scheduled advertisement.

The systems and methods of the present invention may be employed for use Internet advertising management. In one embodiment, an Internet network content provider may provide advertisements displayed as “pop-up” web-pages. A scheduled programmed first “pop-up” advertisement may be replaced by a second advertisement in a similar manner as described above. Alternative embodiments may include replaceable advertisements displayed on a web-page containing additional content unrelated to the product or service being displayed.

The systems and methods of the present invention may be employed for use in radio broadcasts. A scheduled first advertisement may be replaced by a second advertisement in a commercial break broadcast during a radio program, using the pricing methodology described above. In alternative embodiments, the systems and methods of the present invention may be employed in any additional field in which advertisements are broadcast to viewers.

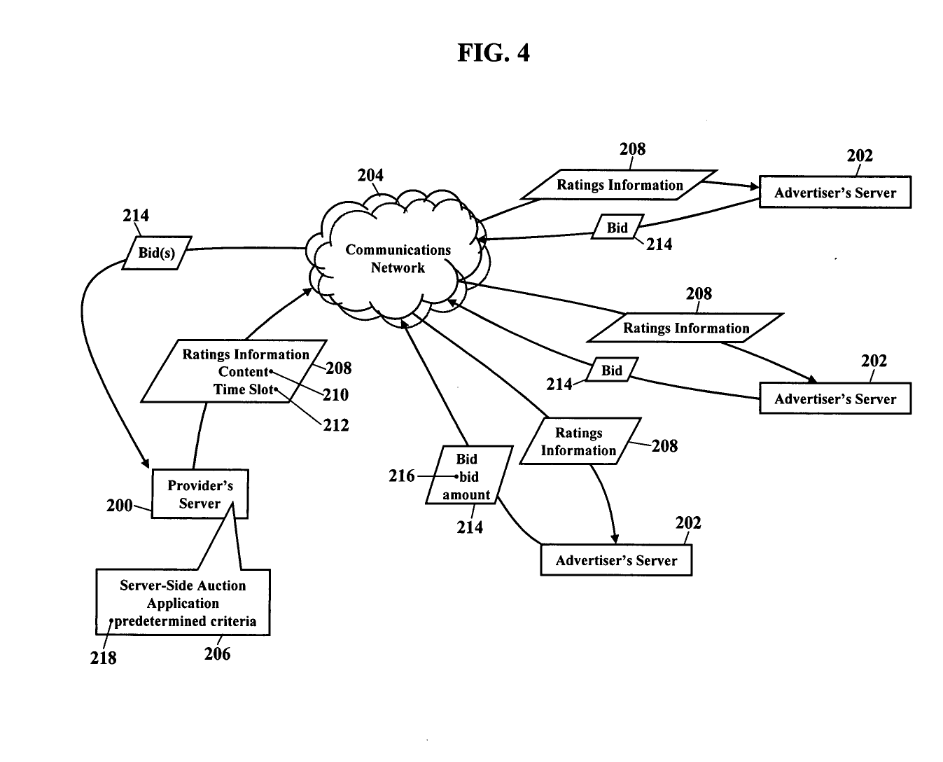

FIG. 4 is a simplified schematic illustrating another exemplary operating environment. Here a provider's server 200 communicates with multiple advertisers' servers 202 via a communications network 204. The provider's server 200 stores and executes a server-side auction application 206. The server-side auction application 206 conducts an online, real-time auction amongst the advertisers' servers 202. The provider's server 200 sends ratings information 208 to the advertisers' servers 202. The ratings information 208 describes the popularity of some content 210 that is associated with a time slot 212. That is, the ratings information 208 statistically describes how many people, households, and/or devices are receiving the content 210 that contains or includes the time slot 212. The content 210 may be any audio/video programming or file that is broadcast, multi-cast, or uni-cast over the wired or wireless communications network 204. When the advertisers' servers 202 receive the ratings information 208, the advertisers' servers 202 submit bids 214 to the provider's server 200. Those bids 214 typically include some bid amount 216 that an advertiser is willing to pay to have their advertisement inserted into, or associated with, the time slot 212. When the provider's server 200 receives the bids 214, the server-side auction application 206 evaluates those bids 214 according to predetermined criteria 218.

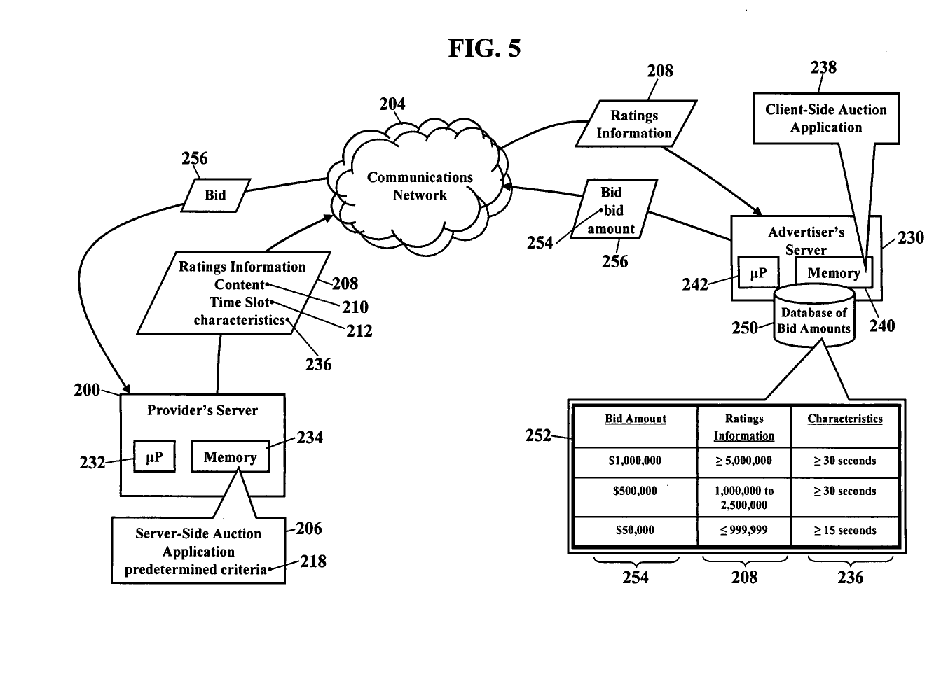

FIGS. 5-7 are more detailed schematics illustrating management of the advertisement time slot 212, according to more exemplary embodiments. FIG. 5, for simplicity, only illustrates a single advertiser's server 230 that communicates with the provider's server 200. The multiple advertisers' servers (shown as reference numeral 202 in FIG. 4) may, however, use similar communications when vying for the auction time slot 212. The provider's server 200 has a processor 232 (e.g., “μP”), application specific integrated circuit (ASIC), or other similar device that executes the server-side auction application 206 stored in memory 234. The server-side auction application 206 comprises processor-executable instructions that conduct the online, real-time auction with the advertiser's server 230. The server-side auction application 206 sends the ratings information 208 to the advertiser's server 230. The server-side auction application 206 may also send characteristics 236 that describe the time slot 212, such as the length of time of the time slot 212 and any formatting requirements for the time slot 212. When the advertiser's server 230 receives the ratings information 208 and the characteristics 236, a client-side auction application 238 evaluates the ratings information 208 and the characteristics 236. The client-side auction application 238 comprises processor-executable instructions that are stored in the memory 240 of the advertiser's server 230. The client-side auction application 238 instructs a client processor 242 to evaluate the ratings information 208 and the characteristics 236.

The advertiser's server 230 then decides whether to bid for the time slot 212. The client-side auction application 238, for example, may query a database 250 of bid amounts. The database 250 of bid amounts is illustrated as table 252 that maps, relates, or otherwise associates bid amounts 254 to the ratings information 208 and to the characteristics 236 of the time slot 212. The database 250 of bid amounts is illustrated as being locally stored in the memory 240 of the advertiser's server 230, yet the database 250 of bid amounts may be remotely accessible via the communications network 204. The database 250 of bid amounts stores varying prices that the advertiser is willing to pay for the time slot 212. Those prices may depend upon the length of the time slot 212, how popular the content is that is related to the time slot 212, and whether an advertisement's formatting is compatible with the time slot 212. The database 250 of bid amounts may store fine distinctions in the bid amounts that are related to many ranges of ratings information. The database 250 of bid amounts may alternatively store only a few bid amounts that are related to broad ranges of ratings information. Likewise, the bid amounts 254 may finely or broadly related to the characteristics 236 of the time slot 212. However the bid amounts 254 are defined, the client-side auction application 238 retrieves the bid amount 254 that the advertiser is willing to pay for the time slot 212. The advertiser's server 230 then sends the bid amount 254 as a bid 256 for the time slot 212.

The ratings information 208 may determine the bid amount 254. Because the ratings information 208 statistically describes the popularity of the content associated with the time slot 212, the ratings information 208 may describe the number of devices and/or households that are currently receiving the content. The ratings information 208 may be expressed as a percentage of devices or households out of a total population of subscribers. The ratings information 208 may be expressed by geographic region or demographic profile (e.g., age, income, sex). When the ratings information 208 indicates that the content is being received by a desirable amount of devices/households, the advertiser may wish to make a larger bid for the corresponding time slot. Conversely, when the ratings information 208 is low, the advertiser may make a small bid or even no bid.

The characteristics 236 of the time slot 212 may also determine the bid amount 254. The characteristics 236 describe any constraints that are imposed on the time slot 212. The characteristics 236, for example, may describe a duration of the time slot 212, and longer durations in popular content may require larger bids. The characteristics 236 may describe whether the time slot 212 will be locally, regionally, or nationally broadcasted or multi-casted. Higher bid amounts may be expected for greater distribution, while lower bid amounts may be made for unicast distribution to a relatively low number of devices. The characteristics 236 may also describe bandwidth or byte constraints that may limit what advertising content is insertable into the time slot 212. If the time slot 212 can only accept a small byte-size advertisement (such as a black and white ad or a simple text ad), then the bid amount 254 may be smaller. If the time slot 212 can support a sophisticated or large byte-size advertisement (such as an MPEG color video), then the bid amount 254 may be large.

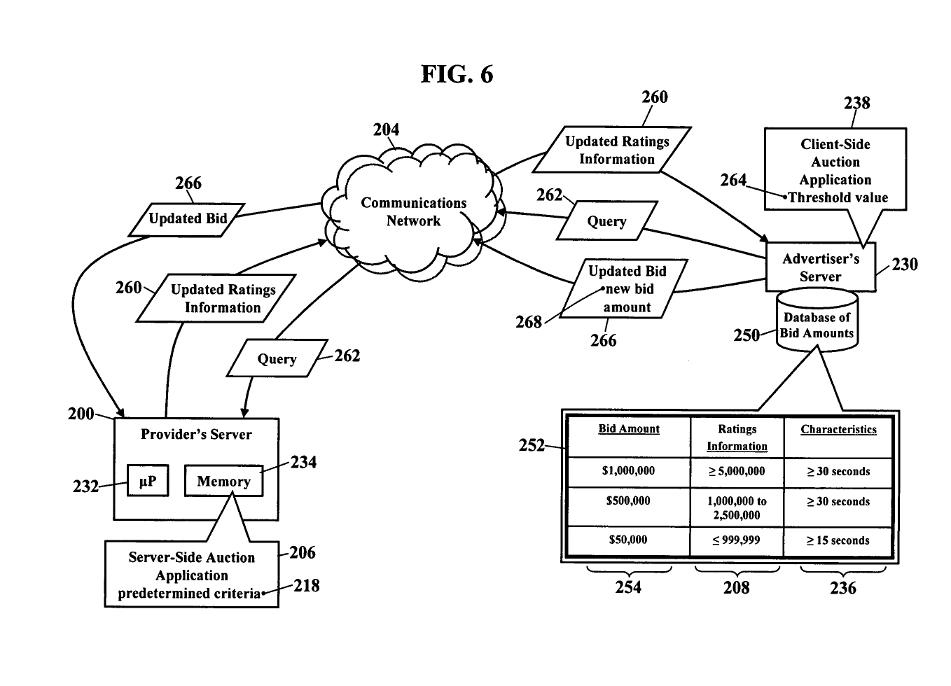

As FIG. 6 illustrates, the advertiser may obtain updated ratings information 260. After the bid amount (shown as reference numeral 254 in FIG. 5) has been sent, the client-side auction application 238 may periodically send a query 262 for new ratings information. Because the provider's server 200 is conducting a real-time (or near real-time) auction for the time slot 212, advertisers may wish to recursively obtain the most recent ratings information. Viewership may increase and decrease as the content progresses. Subscribers may grow tired of content that doesn't live up to the “hype.” Viewership may grow when an important scene approaches or when a sporting event will have a dramatic finish. For many reasons, then, advertisers may not want to make bids based on stale information. Advertisers, instead, may wish to obtain the updated ratings information 260 that most accurately describes the number of viewers who will receive the time slot 212. While the query 262 is illustrated as communicating to the provider's server 200, the query 262 may instead be addressed to any server or network destination that provides the updated ratings information 260.

Advertisers may refine their bids. Whenever the client-side auction application 238 receives the updated ratings information 260, the updated ratings information 260 may be compared to one or more threshold values 264. The threshold value 264 is any configurable parameter that determines when the advertiser wishes to refine their bid. When, for example, the updated ratings information 260 is less than the threshold value 264, then the advertiser may wish to retract the previously-submitted bid (shown as reference numeral 256 in FIG. 5). When the content isn't as popular as originally thought, the advertiser may wish to retract and submit a lower bid amount that reflects the lower popularity. Likewise, when the updated ratings information 260 is greater than the threshold value 264, then the content is more popular that originally estimated, so the advertiser may wish to retract and submit a higher bid amount. When the client-side auction application 238 determines that a new bid should be submitted, the client-side auction application 238 may again query the database 250 of bid amounts using the updated ratings information 260. The client-side auction application 238 then sends an updated bid 266 with a new bid amount 268 that reflects the updated ratings information 260.

The auction is thus used to manage the time slot 212. Because the advertiser receives real-time (or near real-time) ratings information, the advertiser may adequately evaluate how many households and/or devices are receiving the advertisement. The advertiser is not solely relying on estimated ratings. Moreover, the network or content provider may take advantage of surges in ratings to obtain higher fees for the auctioned time slot 212. The server-side auction application 206 may even notify the auction participants of competing bids, thus intensifying competition for the time slot 212. The provider's strategy will determine whether or not the participating advertisers are informed of each bid amount.

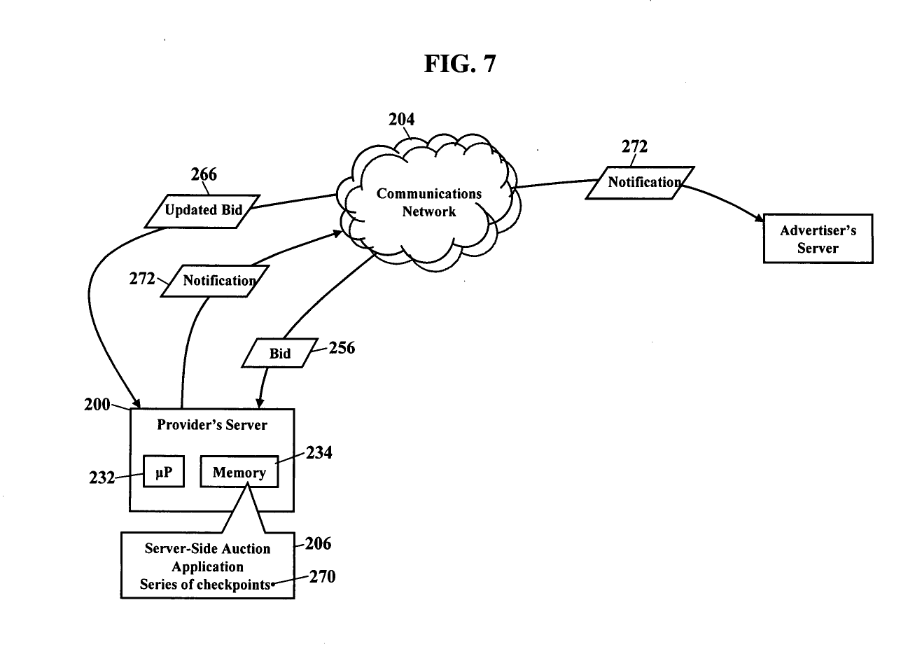

FIG. 7 illustrates notifications. The server-side auction application 206 receives the advertiser's initial bids 256 and any updated bids 266 that reflect the updated ratings information (shown as reference numeral 260 in FIG. 6). The server-side auction application 206 then evaluates the submitted bids according to the series 270 of checkpoints. The series 270 of checkpoints represent conditions or rules for selecting a winning bid. Once the winning bid is chosen, the server-side auction application 206 sends a notification 272 to the advertiser's server 230. The notifications 272 may inform the advertiser of the outcome of the auction. The notifications 272 may even be tailored to each advertiser, thus explicitly detailing why each advertiser won or lost the auctioned time slot 212.

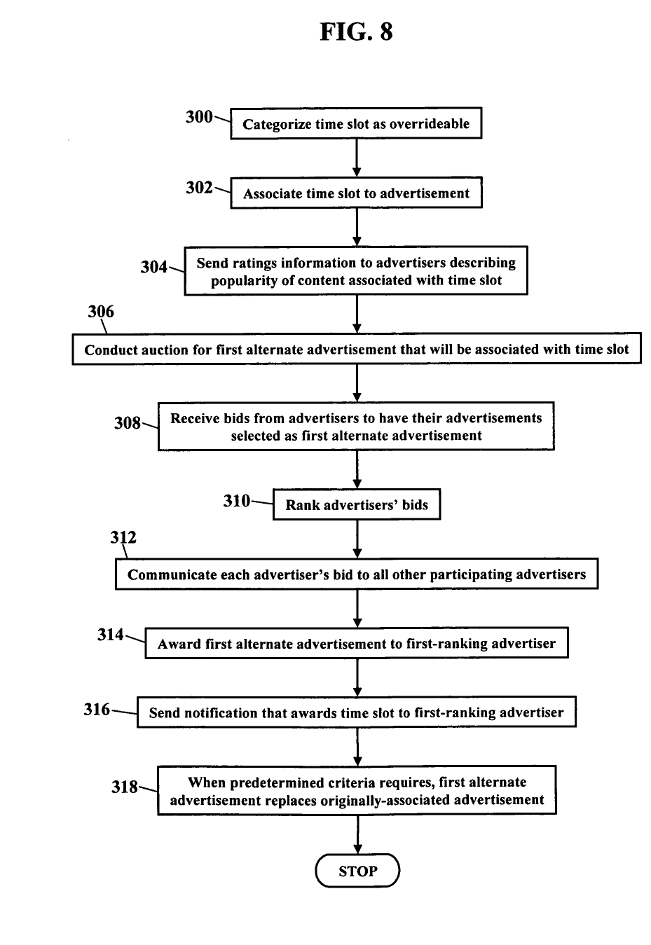

FIG. 8 is a flowchart illustrating a method of management of an advertisement time slot, according to even more exemplary embodiments. Here again an online, real-time auction is conducted amongst multiple advertisers. Here, however, exemplary embodiments conduct an automated, dynamic market for second place, third place, and so on. That is, even if an advertiser does not win the auction for the time slot, here advertisers may still vie for first, second, and third alternates. When the time slot is categorized as overrideable, there is always a chance that the winning bidder's advertisement may not be shown. So, even though an advertiser may not have won the auction, exemplary embodiments still allow the advertisers to vie for alternate positions.

An example provides further explanation. Suppose that the auctioned time slot is associated with the SUPER BOWLS (a registered trademark of NFL Enterprises, LLC). That is, any advertisement inserted into, or associated with, the time slot will be shown during the football game. The time slot is auctioned, and a winning bidder is selected. The winning bid, however, is conditional. The winning bidder is willing to pay the highest price to have their advertisement inserted into the time slot, but only if the ratings information satisfies a threshold value. The winning bidder, in other words, will only pay the winning bid when viewership meets or exceeds some threshold value. If the ratings information falls below the threshold value, then the advertiser will retract their bid. The time slot, then, is overrideable and, once again, available for contention. That is, even if an advertiser is not willing to pay the highest price, there is still a chance of eventually winning the time slot. Each advertiser's bid may have conditions, and those conditions may differ according to the business strategies of each advertiser. When the time slot is overrideable, though, those conditions may make the time slot always available for contention.

FIG. 8 illustrates this dynamic market for alternate positions. The time slot is categorized as overrideable (Block 300) and is associated to an advertisement (Block 302) (that is, somehow an advertisement has been selected for the time slot, but how the advertisement is selected is not important). Real-time (or near real time) ratings information is sent to advertisers that describes a popularity of content associated with the time slot (Block 304). An auction is conducted for a first alternate advertisement that will be associated with the time slot (Block 306). Bids are received from the advertisers to have their advertisements selected as the first alternate advertisement (Block 308). The advertisers' bids are ranked (Block 310). Each advertiser's bid may be communicated or revealed to all other participating advertisers (Block 312). The first alternate advertisement is awarded to a first-ranking advertiser (Block 314). A notification may be sent that awards the time slot to the first-ranking advertiser (Block 316). When predetermined criteria requires, the first alternate advertisement replaces the original advertisement (Block 318). FIG. 8, then, illustrates how exemplary embodiments manage the time slot as an advertising opportunity that is always in contention.

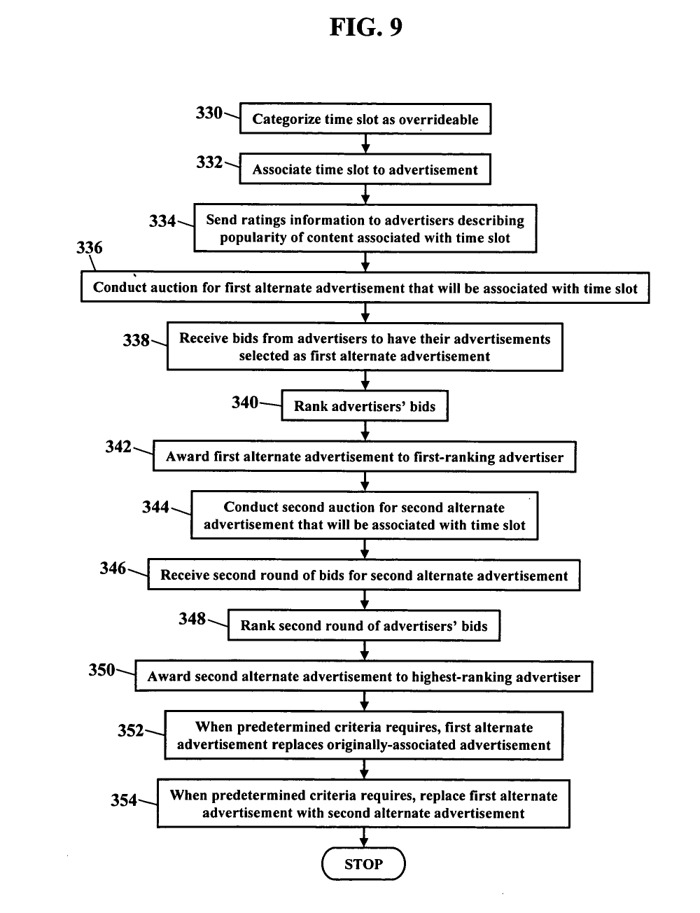

FIG. 9 is a flowchart illustrating another method of management of a time slot, according to more exemplary embodiments. Because some portions of FIG. 9 are similar to FIG. 8, those similar portions are only briefly described. The time slot is categorized (Block 330) and associated to an advertisement (Block 332). The ratings information is sent to the advertisers (Block 334). An auction is conducted for the first alternate advertisement (Block 336) and bids are received from the advertisers (Block 338). The advertisers' bids are ranked (Block 340) and the first alternate advertisement is awarded to the first-ranking advertiser (Block 342). A second auction is conducted for a second alternate advertisement that will be associated with the time slot (Block 344). A second round of bids is received from the advertisers to have their advertisements selected as the second alternate advertisement (Block 346). The advertisers' second round of bids is ranked (Block 348) and the second alternate advertisement is awarded to a highest-ranking advertiser (Block 350). When the predetermined criteria requires, the first alternate advertisement replaces the original advertisement (Block 352). When the predetermined criteria requires, the first alternate advertisement is replaced with the second alternate advertisement (Block 354). FIG. 9, then, illustrates how exemplary embodiments create and manage contention for first and second alternate advertisers who may still have their respective advertisement selected for the time slot.

Additional alternate positions may be selected. Those of ordinary skill in the art should recognize that exemplary embodiments may be applied to any number of auctions for alternate positions. FIG. 9, for example, may be extended to a third auction for a third alternate advertisement that will be associated with the time slot. A third round of bids is received and ranked. A third alternate advertisement is then awarded to a highest-ranking advertiser of this third auction. A fourth auction, a fifth auction, any other number of auctions may similarly be held.

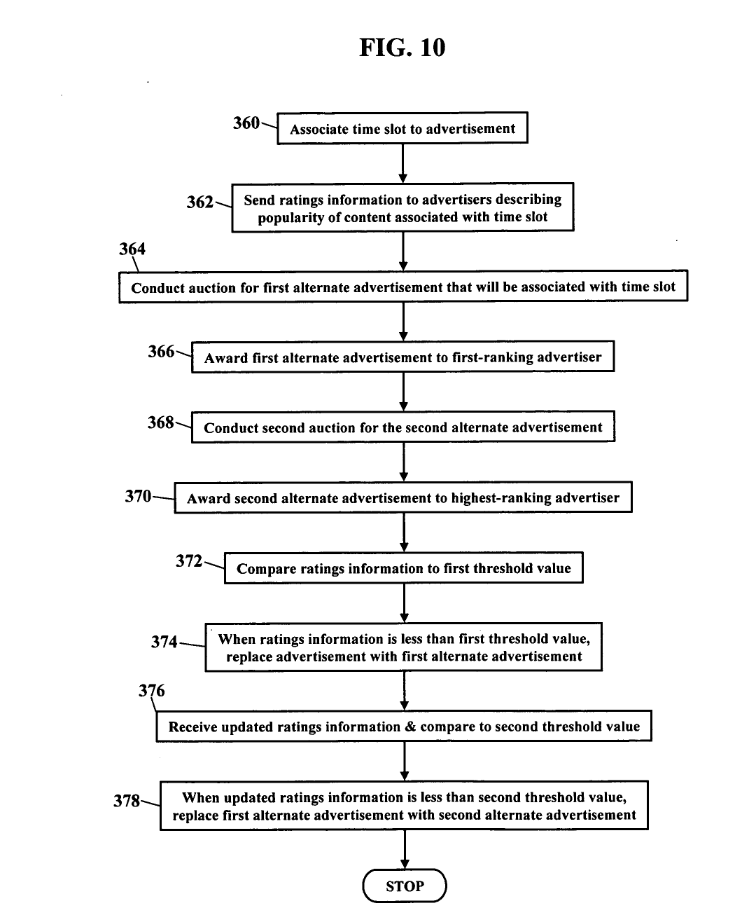

FIG. 10 is a flowchart illustrating still another method of management of a time slot, according to still more exemplary embodiments. The time slot is associated to an advertisement (Block 360) and ratings information is sent to the advertisers (Block 362). A first auction is conducted for the first alternate advertisement (Block 364) and the first alternate advertisement is awarded to the first-ranking advertiser (Block 366). A second auction is conducted for the second alternate advertisement (Block 368) and the second alternate advertisement is awarded to the highest-ranking advertiser in the second auction (Block 370). The ratings information is compared to a first threshold value (Block 372). When the ratings information is less than the first threshold value, then the advertisement is replaced with the first alternate advertisement (Block 374). Updated ratings information is received and compared to a second threshold value (Block 376). When the ratings information is less than the second threshold value, then the first alternate advertisement is replaced with a second alternate advertisement (Block 378).

Exemplary embodiments may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments. A computer program product comprises processor-executable instructions for managing a time slot.

The foregoing is provided to explain and disclose preferred embodiments of the present invention, modifications to which may be made that still fall within the following claims. For instance, the architecture and programming of the system may be modified. Or, a variety of different manufacturers' servers or databases may be configured in order to implement the system. Further modifications and adaptations to the described embodiments will be apparent to those skilled in the art and may be made without departing from the scope or spirit of the invention and the following claims.

What is claimed is:

1. A processor-implemented method of managing an advertisement time slot, comprising:
associating the time slot to an advertisement;
sending ratings information to advertisers that describes a popularity of content associated with the time slot;
conducting an auction for a first alternate advertisement that will be associated with the time slot;
receiving bids from the advertisers to have their advertisements selected as the first alternate advertisement;
ranking the advertisers' bids; and
awarding the first alternate advertisement to a first-ranking advertiser.

2. The method of claim 1, further comprising categorizing the time slot as overrideable, wherein the advertisement associated with the time slot may be replaced with the alternate advertisement.

3. The method of claim 1, further comprising replacing the advertisement with the first alternate advertisement according to predetermined criteria.

4. The method of claim 3, further comprising conducting a second auction for a second alternate advertisement that will be associated with the time slot.

5. The method of claim 4, further comprising receiving a second round of bids from the advertisers to have their advertisements selected as the second alternate advertisement.

6. The method of claim 5, further comprising ranking the advertisers' second round of bids and awarding the second alternate advertisement to a highest-ranking advertiser.

7. The method of claim 6, further comprising replacing the first alternate advertisement with the second alternate advertisement.

8. The method of claim 1, further comprising comparing the ratings information to a first threshold value.

9. The method of claim 8, wherein when the ratings information is less than the first threshold value, then replacing the advertisement with the first alternate advertisement.

10. The method of claim 9, further comprising comparing the ratings information to a second threshold value.

11. The method of claim 10, wherein when the ratings information is less than the second threshold value, then replacing the first alternate advertisement with a second alternate advertisement.

12. The method of claim 1, further comprising communicating each advertiser's bid to all other advertisers.

13. The method of claim 1, further comprising sending a notification that awards the time slot to the first-ranking advertiser.

14. A system for managing an advertisement time slot, the system operative to:
associate the time slot to an advertisement;
send ratings information to advertisers that describes a popularity of content associated with the time slot;
conduct an auction for a first alternate advertisement that will be associated with the time slot;
receive bids from the advertisers to have their advertisements selected as the first alternate advertisement;
rank the advertisers' bids; and
award the first alternate advertisement to a first-ranking advertiser.

15. The system of claim 14, further operative to replace the advertisement with the first alternate advertisement according to predetermined criteria.

16. The system of claim 15, further operative to conduct a second auction for a second alternate advertisement that will be associated with the time slot.

17. The system of claim 16, further operative to receive a second round of bids from the advertisers to have their advertisements selected as the second alternate advertisement.

18. The system of claim 17, further operative to rank the advertisers' second round of bids and award the second alternate advertisement to a highest-ranking advertiser.

19. The system of claim 18, further operative to replace the first alternate advertisement with the second alternate advertisement.

20. The system of claim 18, further operative to:
compare the ratings information to a first threshold value and to a second threshold value;
when the ratings information is less than the first threshold value, then replace the advertisement with the first alternate advertisement; and
when the ratings information is less than the second threshold value, then replace the first alternate advertisement with a second alternate advertisement.
